(19) United States
(12) Patent Application Publication
(10) Pub. No.: US 2015/0369933 A1
(43) Pub. Date: Dec. 24, 2015

(54) SHELL FOR A RADIATION SENSOR

(71) Applicant: Saint-Gobain Ceramics & Plastics, Inc., Worcester, MA (US)

(72) Inventors: Artan Duraj, Seven Hills, OH (US); John M. Frank, Hartville, OH (US); Michael L. Bush, Ravenna, OH (US)

(21) Appl. No.: 14/725,704

(22) Filed: May 29, 2015

Related U.S. Application Data
(60) Provisional application No. 62/005,554, filed on May 30, 2014.

(51) Int. Cl. G01T 7/00; G01M 7/08

(52) U.S. Cl. CPC G01T 7/00; G01M 7/08

(57) ABSTRACT

A shell for a radiation sensor comprising a body defining an aperture adapted to receive a radiation sensing component; and a plurality of fins outwardly extending from the body, wherein an axial distance between a first pair of adjacent fins is different from an axial distance between a second pair of adjacent fins.

### CROSS-REFERENCE TO RELATED APPLICATION(S)

The present application claims priority from U.S. Provisional Patent Application No. 62/005,554, filed May 30, 2014, entitled, “SHELL FOR A RADIATION SENSOR,” naming inventors Artan Duraj, John M. Frank and Michael L. Bush, and said provisional application is incorporated by reference herein in its entirety for all purposes.

### FIELD OF THE DISCLOSURE

The present disclosure relates to radiation sensors, and more particularly to a shell for a radiation sensor.

### RELATED ART

Radiation sensing equipment is generally sensitive to harsh environments and forces. During operation, radiation sensing equipment, particularly equipment of the handheld variety, may be exposed to physical shock and stress, including force, vibration, and abrasion, any of which may cause irreparable damage or destruction to a radiation sensing component contained in the radiation sensing equipment. In this regard, it is important to protect the radiation sensing equipment by mitigating force transfer to the radiation sensing component. However, it is also important to minimize weight of the radiation sensing equipment. Accordingly, heavy protection schemes and mounts, while potentially effective at mitigating damage, may be unnecessarily cumbersome or may reduce transportability.

A need exists for a shell adapted to receive a radiation sensing component, where the shell can protect the radiation sensing component from physical shock and stress without compromising weight or size.

### BRIEF DESCRIPTION OF THE DRAWINGS

Embodiments are illustrated by way of example and are not limited in the accompanying figures.

FIG. 1 includes a partially cutout perspective side view of a radiation sensor assembly in accordance with an embodiment.

FIG. 2 includes a perspective side view of a shell for a radiation sensor in accordance with an embodiment.

FIG. 3 includes a side elevation view of a shell for a radiation sensor with one half of the shell removed, in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts. Reference to any standard, including an ASTM standard, is made with reference to the version of the standard in affect at the time of filing.

A shell for a radiation sensor in accordance with one or more of the embodiments described herein can generally include a body defining an aperture adapted to receive a radiation sensing component. The shell can further include a plurality of fins outwardly extending from the body. In a particular embodiment, an axial distance between a pair of adjacent fins can be different than an axial distance between another pair of adjacent fins. In another embodiment, a radial height of a fin, as measured by a distance the fin extends from an outer surface of the body can be different than a radial height of another fin.

A radiation sensing assembly in accordance with one or more of the embodiments described herein can generally include a housing having a cavity, a radiation sensing component disposed within the cavity, and a shell disposed within the cavity between the housing and the radiation sensing component. In a particular embodiment, the shell can include a plurality of fins extending in a radial direction. In a more particular embodiment, at least one of the fins can extend to an inner surface of the housing. The fins can secure the radiation sensing component within the housing, mitigating rattle and reducing transmission of shock.

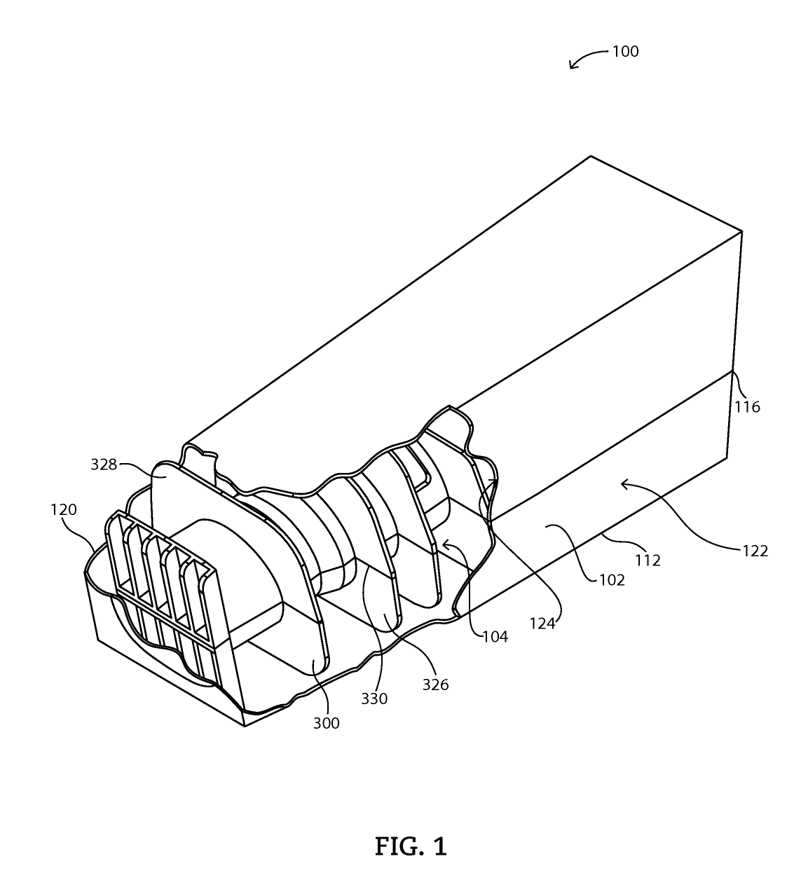

Referring now to the figures, FIG. 1 includes a partial cross section of a radiation sensing assembly 100 in accordance with an embodiment. The radiation sensing assembly 100 generally includes a housing 102 defining a cavity 104. The cavity 104 can be defined by an inner sidewall of the housing 102. In a particular embodiment, the cavity 104 can be sealed, such that fluids, such as, for example, water under normal operating temperature and pressure conditions, cannot pass through the housing 102 and enter the cavity 104. As used herein, “normal operating temperature and pressure conditions” refers to the temperatures and conditions encountered during routine operation of the radiation sensing assembly 100.

In a particular embodiment, the housing 102 can further include a handle or a user input/output feature, such as, for example, a user display, a control element (for example, one or more buttons or switches), or any combination thereof. In a non-limiting embodiment, the handle may include knurling, ribs, dimples, or another similar grip enhancing feature. Moreover, the handle may be grooved or otherwise shaped to more closely align with and simulate the contours of a human hand. Although the radiation sensing assembly 100 is illustrated as a single unit, skilled artisans will appreciate that the device may include multiple individual components attached or arranged in various configurations.

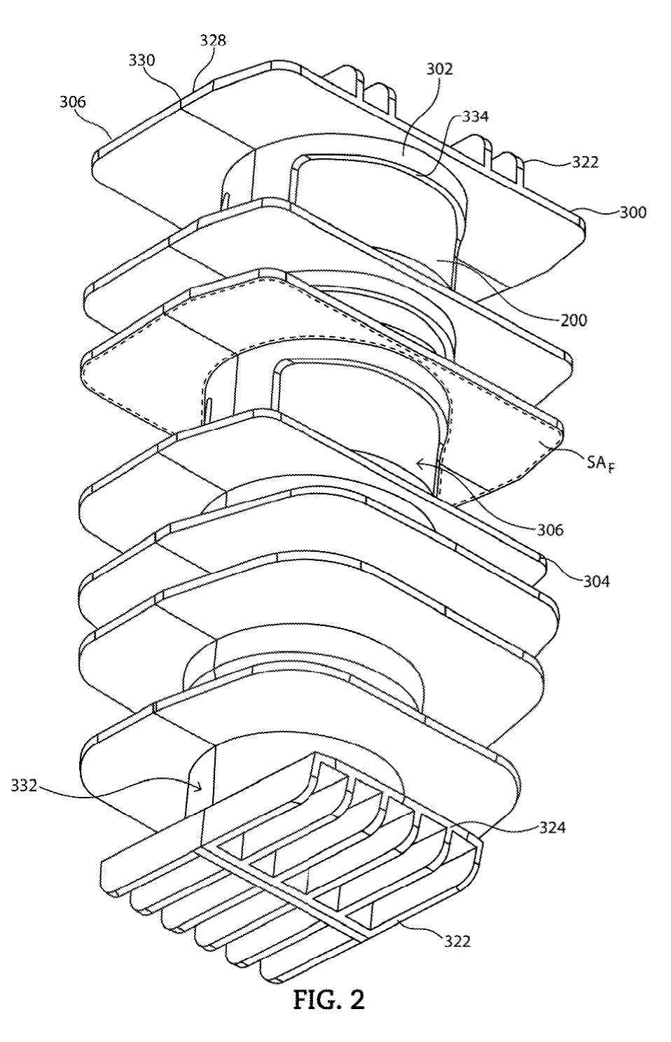

In a particular embodiment, the housing 102 can include at least two components—a bottom component 112 and a top component 114 engaged along a joint 116. The joint 116 can extend at least partially around the housing 102 in a manner such that the two components 112 and 114 can be disengaged to reveal the cavity 104. In such a manner, a radiation sensing component 200 (FIG. 2) disposed within the cavity 104 of the housing 102 can be accessed.

As contemplated in one or more of the embodiments described herein, the joint 116 can lie substantially along a plane. In such a manner, both components 112 and 114 of the housing 102 can be engaged at a planar junction. This may allow for easier assembly of the components 112 and 114 as compared to a nonplanar, or stepped, joint.

In a further embodiment, the housing 102 can further include a hinge (not illustrated) disposed at or adjacent the joint 116. In a particular embodiment, the hinge can permit the components 112 and 114 of the housing 102 to be pivotally urged open and closed.

In a particular embodiment, the radiation sensing assembly 100 can further include an end cap 120. The end cap 120 can be disposed at an axial end of the housing 102. The end cap 120 can engage both components 112 and 114 and, in a non-limiting embodiment, can help secure the two components 112 and 114 together. The end cap 120 can include a dampener to mitigate a transmission of force, e.g., shock, to the radiation sending component 200 upon sudden impact.

In a particular embodiment, the radiation sensing assembly 100 can be front weighted or have an otherwise nonsymmetrical center of gravity such that if dropped, impact with a lower surface can occur at a location at, or near, the end cap 120.

Referring now to the radiation sensing component 200 disposed within the housing 102, in accordance with one or more embodiments described herein, the radiation sensing component 200 can be a medical imaging apparatus, a well logging apparatus, a security inspection apparatus, nuclear physics applications, or the like. In a particular embodiment, the radiation detection system can be used for gamma ray analysis, such as a Single Photon Emission Computed Tomography (SPECT) or Positron Emission Tomography (PET) analysis.

In an embodiment, the radiation sensing component 200 can include a scintillator. The scintillator can include a metal halide, a rare earth oxide, a rare sulfide, a rare earth oxysulfide, an organic scintillation material, or another suitable scintillation material. Such scintillators may or may not include an activator.

In a particular embodiment, the radiation sensing component 200 can include a scintillator and a photo sensor. The photo sensor can include, for example, a photo multiplier tube, a photo diode, or a hybrid thereof. The scintillator and the photo sensor can be optically coupled to provide an electrical signal for processing.

In another embodiment, the radiation sensing component 200 can include an organic scintillation material. In a particular embodiment, the organic scintillation material can include an aromatic compound. In a particular embodiment, the aromatic compound can be a homoaromatic compound or a heteroaromatic compound. In a more particular embodiment, the aromatic compound includes a phenyl or pyrazoline aromatic compound. In an embodiment, the combination of the organic scintillation material and the solvent can be mixed into and dissolve within the polymer matrix.

Radiation sensing components 200 can be fragile, and may become damaged or destroyed upon exposure to environmental conditions or forces.

In accordance with a particular embodiment described herein, the radiation sensing assembly 100 further includes a shell 300. The shell 300 can be disposed at least partially between the radiation sensing component 200 and the housing 102. More particularly, the shell 300 can extend around a majority, or all, of the radiation sensing component 200. The shell 300 can reduce or eliminate transmission of shock, vibration, abrasion, or any similar force, to the radiation sensing component 200. The shell 300 may extend the operating life of the radiation sensing component 200.

Referring now to FIG. 2, in a particular embodiment, the shell 300 can include a body 302 and a plurality of fins 304. The plurality of fins 304 can extend outwardly from the body 302. In a particular embodiment, each fin 304 of the plurality of fins can extend perpendicular to an outer surface of the body 302. At least one of the plurality of fins 304, and more preferably at least two of the plurality of fins 304, can extend from the body 302 to an inner surface 124 of the housing 102 so as to contact both the body 302 and the housing 102. In such a manner, the shell 300 can reduce or prevent the radiation sensing component 200 from moving or rattling within the cavity 104 of the housing 102. In yet another embodiment, all of the fins 304 can extend from the body 302 so as to contact the housing 102.

The body 302 can define an aperture 306 adapted to receive the radiation sensing component 200. In a particular embodiment, the aperture 306 can have a diameter that is no greater than the diameter of the radiation sensing component 200. In a more particular embodiment, the aperture 306 can have a diameter, as measured at any location along an axial length of the aperture 306, that is slightly less than the diameter of the radiation sensing component 200 (e.g., 1% less) as measured at the same axial location. In such a manner, the shell 300 can form an interference fit with the radiation sensing component 200. In another more particular embodiment, the aperture 306 can have a diameter that is equal to the diameter of the radiation sensing component 200, as measured at the same axial location.

In an embodiment, the radiation sensing component 200 can be at least partially polygonal, e.g., the radiation sensing component 200 can include a polygonal surface, or otherwise non-ellipsoidal portion. In such embodiment, the aperture 306 can be sized to receive the non-ellipsoidal or polygonal radiation sensing component 200 as described above. For example, the aperture 306 can have a profile similar to the radiation sensing component 200, with a size that is slightly less than the radiation sensing component 200.

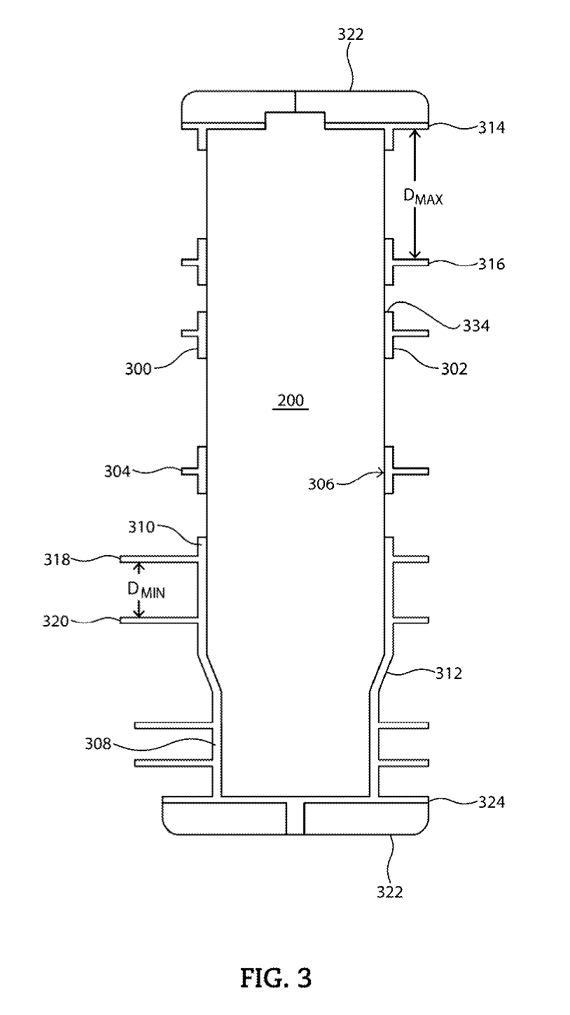

Referring to FIG. 3, in an embodiment, the aperture 306 can include a portion 308 and a portion 310. The portion 308 can have a diameter that is less than the diameter of the portion 310. Moreover, a portion 312 can be disposed axially between the portions 308 and 310. The portion 312 can connect the portions 308 and 310. In a more particular embodiment, the portions 308, 310, and 312 can be contiguous. In yet a more particular embodiment, the portions 308, 310, and 312 can be shaped to receive a radiation sensing component 200 having any outer profile and configuration. In this regard, the aperture 306 can take the shape of the radiation sensing component 200.

In a particular embodiment, the shell 300 can at least partially comprise an elastomer. In a non-limiting embodiment, by way of example, the shell 300 can at least partially comprise a polyisoprene from an organic or synthetic source, a chloroprene rubber, a polybutadiene, a copolymer of styrene and butadiene, a copolymer of butadiene and acrylonitrile, an ethylene-propylene-diene rubber, a chlorosulfonated polyethylene, a chlorinated polyethylene, a polyacrylate rubber, a polysulfide rubber, an epichlorohydrin, a urethane, a polybutylene, an ethylene acrylic rubber, a fluorocarbon rubber, a polytetrafluoroethylene-propylene, a silicone polydimethylsiloxane rubber, a fluorosilicone, a polyphosphazene rubber, a polyoctenylene, a polypropylene oxide rubber, a polynorbornene, or any combination thereof.

In an embodiment, the shell 300 can comprise a material having a durometer of no less than 30, as measured according to the Shore A scale of ASTM D2240. In a more particular embodiment, the shell 300 can comprise a material having a durometer of no less than 60, such as no less than 90. In yet a more particular embodiment, the shell 300 can comprise a material having a durometer of 100. In a particular embodiment the shell 300 can include a material having a durometer in a range of 60 and 90. In another particular embodiment, the shell 300 can include a single material or a blend of materials having an overall durometer in a range of 60 and 90.

In accordance with an embodiment, the shell 300 may have a mass of no greater than 1000 g, such as no greater than 750 g, no greater than 500 g, or even no greater than 300 g. In another embodiment, the shell 300 can have a mass of at least 20 g, such as at least 100 g, or even at least 250 g. A lightweight shell 300 (e.g., a shell having a mass of no greater than 1000 g) may be particularly advantageous in portable (e.g., handheld) radiation detectors where even an incremental increase of mass can reduce mobility.

In a particular embodiment, the shell 300 can include one or more openings 334 extending from an outer surface of the body 302 in a direction toward the aperture 306. The openings 334 can extend entirely between the outer surface of the body 302 to the aperture 306. Alternatively, the openings 334 can extend a distance less than the entire distance between the outer surface of the body 302 and the aperture 306. The openings 334 can reduce the mass of the shell 300 without compromising shock absorbing properties thereof.

In a more particular embodiment, the fins 304 can include one or more openings The openings can extend entirely between the thickness of the fins 304 or a distance less than the thickness. Similar to openings 334 the openings in the fins 304 can reduce the mass of the shell 300 without compromising shock absorbing properties thereof.

Referring still to FIG. 3, in a particular embodiment, at least two of the plurality of fins 304, or even all of the plurality of fins 304, can extend from the body 302 in a generally parallel orientation with respect to each other. As used herein, a “generally parallel orientation” refers to a relative angle between planes or lines of no greater than 5°, such as no greater than 4°, no greater than 3°, no greater than 2°, or even no greater than 1°. In yet a more particular embodiment, at least two of the plurality of fins 304, or even all of the plurality of fins 304, can extend from the body 302 in a parallel orientation with respect to each other. As used herein, a “parallel orientation” refers to a relative angle between planes or lines of no greater than 0.1°. Fins having a generally parallel, or parallel, orientation may reduce the transmission of force to the radiation sensing component 200 while simultaneously mitigating movement or rattle.

In a particular embodiment, each fin 304 can define an aspect ratio, as defined by a ratio of a radial height of the fin 304, as measured by a shortest distance from the body 302 to an edge of the fin 304, to a thickness of the fin 304, as measured in a direction perpendicular to the radial height of the fin. In an embodiment, each fin 304 can have a uniform radial height or thickness. In another embodiment, each fin 304 can have a non-uniform radial height or thickness. In embodiments where the fin 304 does not have a uniform radial height or a uniform thickness, the radial height and thickness can be calculated as a maximum radial height or a maximum thickness, respectively.

In a particular embodiment, the aspect ratio of at least one of the fins 304 can be at least 1:1. In a further embodiment, the aspect ratio for all of the fins 304 can be at least 1:1. In a more particular embodiment, the aspect ratio can be at least 1.5:1, such as at least 2:1, n at least 3:1, at least 4:1, or even at least 5:1. The aspect ratio may be no greater than 100:1, such as no greater than 50:1, no greater than 40:1, no greater than 30:1, or even no greater than 20:1. In a preferred embodiment, the aspect ratio is in a range of 3:1 and 15:1. While a larger aspect ratio (e.g., 40:1) may decrease shock transmission to the radiation sensing component 200 by increasing shock absorption, larger aspect ratios can reduce stability of the fins 304, causing the fins 304 to buckle. This may cause failure of the shell 300 over prolonged use.

In a particular embodiment, the fins 304 can be unitary, e.g., monolithic, to the body 302. In another embodiment, the fins 304 can be separate components engaged to the body 302. For example, the fins 304 can be engaged to the body 302 by an adhesive, a threaded or non-threaded fastener, a tongue-and-groove, an interference fit, or any combination thereof. In a particular embodiment, at least one of the fins 304 can be reinforced, for example, by way of a structural core or support extending at least partially along or within the fin 304. Alternatively, the fins 304 can be unreinforced.

Referring again to FIG. 2, each fin 304 can have a surface area, SA_{F}, as measured by a surface area of one face the fin 304 as seen around a circumference of the shell 300. In a particular embodiment, SA_{F} for all of the fins 304 can be equal. In another embodiment at least two of the fins 304 can have different surface areas, SA_{F}, such that the two fins have different sizes. In this regard, each fin 304 can be sized and shaped to fit securely in a housing 102 having a varying inner wall profile.

In a particular embodiment, when viewed in a direction parallel with the axial length of the body 302, at least one of the fins 304 can have a polygonal profile. For example, the at least one fin can have a rectangular profile (e.g., a square profile), a pentagonal profile, a hexagonal profile, a heptagonal profile, or even an octagonal profile. In a more particular embodiment, adjacent sides of the polygonal profile can be devoid of right-corners, e.g., rounded, tapered, beveled, or otherwise altered to eliminate right angles.

In a particular embodiment, when viewed in a direction parallel with the axial length of the body 302 of the shell 300, at least one of the fins 304 can have an at least partially ellipsoidal profile, such as, for example, a partially ovular profile or a partially circular profile. Varying sized and shaped fin profiles may allow the shell 300 to be disposed in cavities 304 having non-uniform or nonconventional shapes. Moreover, shells 300 having varying sized and shaped fins 304 can allow the radiation sensing assembly 100 to accommodate additional elements positioned within the housing 102, such as, for example, electrical circuit boards and other electrical components, housing stabilizers (e.g., cross brackets), electrical and shock dampening elements and layers, or any combination thereof.

Referring again to FIG. 3, by way of a non-limiting, exemplary embodiment, a first pair of adjacent fins 314 and 316 can be separated by an axial distance, D_{MAX}, and a second pair of adjacent fins 318 and 320 disposed at a different location along the body 302 of the shell 300 can be separated by an axial distance, D_{MIN}. In accordance with one or more of the embodiments described herein, D_{MAX} can be at least 1.1 D_{MIN}, such as at least 1.5 D_{MIN}, or even at least 2.0 D_{MIN}. In a more particular embodiment, D_{MAX} can be no greater than 20 D_{MIN}, such as no greater than 10 D_{MIN}, or even no greater than 5 D_{MIN}. In such a manner, relative stiffness and support provided by the shell 300 to the radiation sensing component 200 can be adjusted and engineered to support various radiation sensing components 200 having different structural configurations and component placement schemes. In a more particular embodiment, D_{MAX} can separate a pair of adjacent fins disposed along a first axial end of the shell 300 and D_{MIN} can separate a pair of adjacent fins disposed along a second opposite axial end of the shell 300.

In yet a further embodiment, an axial distance between adjacent fins can increase between successive fins 304, in that the axial distance between each successive fin, as measured along an axial length of the body 302, can be larger than the axial distance between the previous adjacent fins. In a particular embodiment, the smallest axial distance between adjacent fins can be between adjacent fins positioned near the end cap 120. This may reduce or eliminate shock transfer to the radiation sensing component 200 by providing a more heavily concentrated fin density. Moreover, this made reduce the chance of a harmonic between the fins 302 upon exposure to a force.

The shell 300 can define a fin density, FD, as measured by the surface area occupied by the fins 304 per unit area of the body 302. In a particular embodiment, the portion 308 of the body 302 can have a fin density, FD_{P1}, and the portion 310 of the body 302 can have a fin density, FD_{P2}, where FD_{P2} is greater than FD_{P1}. For example, FD_{P2} can be at least 1.1 FD_{P1}, such as at least 1.2 FD_{P1}, at least 1.5 FD_{P1}, or even at least 2.0 FD_{P1}. In a more particular embodiment, FD_{P2} can be no greater than 10.0 FD_{P1}, such as no greater than 5.0 FD_{P1}, or even no greater than 2.5 FD_{P1}.

Conversely, in another embodiment, FD_{P1} can be greater than FD_{P2}. Alternatively, FD_{P2} can be equal to FD_{P1}. Of significance, the fin density can be designed and engineered, e.g., specifically selected, along various locations along the body 302 depending on the structural configuration and component placement scheme of the radiation sensing component 200 being used in the radiation sensing assembly 100. For example, if a delicate portion of the radiation sensing component 200 is positioned along the portion 308, the fin density of that portion can be increased relative to the portion 310. Alternatively, if a more delicate portion of the radiation sensing component 200 is positioned along the portion 310, the fin density of that portion can be increased relative to the portion 308.

Referring now to FIGS. 1 to 3, in a particular embodiment, the shell 300 can further include at least one axial fin 322 extending from an axial end of the body 302. The axial fin(s) 322 may include at least 2 fins, at least 3 fins, at least 5 fins, at least 10 fins, at least 15 fins, or even at least 20 fins. In a particular embodiment, the axial fins 322 may include no greater than 100 fins, no greater than 75 fins, or even no greater than 50 fins.

In a particular embodiment, the axial fins 322 may be disposed along a plate 324 and may extend therefrom. The plate 324 may be oriented parallel with at least one of the fins 304 and may form an axial end of the radiation sensing component 200. The axial fins 322 may have any similar quality or characteristic as compared to the fins 304. For example, similar to the fins 304, the axial fins may be unitary, e.g., monolithic, to the body 302. In another embodiment, the axial fins 322 can be separate components engaged to one of the body 302 or plate 324. In a particular embodiment, at least one of the axial fins 322 can be reinforced, for example, by way of a structural core or support extending at least partially along or within the axial fin 322. Alternatively, the axial fins 322 can be unreinforced.

In a more particular embodiment, and as illustrated in FIG. 2, the shell 300 can include at least one axial fin 322 extending from both of the axial ends of the body 302 in opposite directions parallel with an axial length of the body 302. In this regard, the axial fins 322 can protect against impacts occurring at either axial end of the radiation sensing assembly 100.

In a particular embodiment, the shell 300 can include two separate components 326 and 328, e.g., two separate halves, joined along a seam 330. The seam 330 can extend at least partially around the shell 300 in a manner such that the two components 326 and 328 can be disengaged. In such a manner, a radiation sensing component 200 disposed within the aperture 306 of the shell 300 can be accessed. As contemplated in one or more of the embodiments described herein, the seam 330 can lie substantially along a plane. In such a manner, both components 326 and 328 of the shell 300 can be engaged along a plane.

As illustrated in FIG. 1, in the assembled state, the seam 330 and the joint 116 can lie along similarly oriented planes. For example, in a particular embodiment as illustrated in FIG. 1, the seam 330 and the joint 116 can lie along parallel planes, e.g., the seam 330 and the joint 116 can lie along planes that do not intersect at any location. In another embodiment, the seam 330 and the joint 116 can lie along planes that are angularly offset. For example, the seam 330 and the joint 116 can be offset by at least 1°, such as at least 5°, at least 10°, at least 15°, at least 20°, or even at least 25°. More particularly, the seam 330 and the joint 116 can be offset by no greater than 45°, such as no greater than 40°, no greater than 35°, or even no greater than 30°.

In another embodiment, the seam 330 can lie along a major surface 332 (FIG. 2) of the shell 300 and the joint 116 can lie along a major surface 122 (FIG. 1) of the housing 102, where the major surfaces 332 and 122 of the housing 102 and the shell 300 extend in parallel at one or more locations. It has been found that positioning the seam 330 and joint 116 in an alignment scheme as described above can facilitate easier assembly of the radiation sensing assembly 100 and can reduce the radial compression forces necessary to fit the shell 300 (including the radiation sensing component 200) into the cavity 104. Moreover, said alignment scheme may facilitate easier access of the radiation sensing component 200 for repair or replacement by eliminating the need to remove the entire shell 300 from the housing 102. Instead, only the uppermost components of the housing 102 and shell 300 (illustrated as components 114 and 328 in FIG. 1, respectively) need be removed for repair. In embodiments where the shell 300 does not have a planar major surface (e.g., as illustrated in FIG. 2 the shell has a cylindrical surface), the major surface can be described as that portion of the surface that is parallel, or generally parallel (e.g., within 25°), with the major surface 122 of the housing 102 upon assembly.

The shell 300 can be tested for force transmission by the Machine Shock Test. The Machine Shock Test utilizes a radiation sensing component (or simulated component having a similar structural size, shape, and weight) positioned within the aperture of the shell. An accelerometer is attached to the radiation sensing component. A force of 120 G-force is transmitted to the shell, once per cycle for 100 cycles. The peak force (G-Peak) and pulse widths can be determined from the accelerometers. A maximum and average peak force can be determined and a minimum and average pulse width can be determined. The pulse width is measured baseline to baseline.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. A shell for a radiation sensor comprising:
a body defining an aperture adapted to receive a radiation sensing component; and
a plurality of fins outwardly extending from the body, wherein an axial distance between a first pair of adjacent fins is different from an axial distance between a second pair of adjacent fins.

Item 2. A shell for a radiation sensor comprising:
a body defining an aperture adapted to receive a radiation sensing component; and
a plurality of fins outwardly extending from the body,
wherein the plurality of fins extend a radial distance from the body, and wherein a radial distance of a first fin from an outer surface of the body is different than a radial distance of a second fin as measured from the outer surface of the body.

Item 3. A shell for a radiation sensor comprising:
a body defining an aperture adapted to receive a radiation sensing component; and
a plurality of fins outwardly extending from the body, each fin defining an aspect ratio as defined by a ratio of a radial height of the fin to a thickness of the fin, and wherein the aspect ratio is greater than 1:1.

Item 4. A shell for a radiation sensor, wherein the shell is adapted to transmit a G-peak, as measured according to the Machine Shock Test, of less than 400 G-peak.

Item 5. The shell according to any one of the preceding items, wherein the shell is adapted to transmit a G-peak, as measured according to the Machine Shock Test, of less than 400 G-peak, such as less than 350 G-peak, less than 300 G-peak, less than 250 G-peak, less than 200 G-peak, or even less than 150 G-peak.

Item 6. A shell for a radiation detector, wherein the shell is adapted to transmit a pulse having a pulse width, as measured according to the Machine Shock Test, of no less than 7 ms.

Item 7. The shell according to any one of the preceding items, wherein the shell is adapted to transmit a pulse having a pulsewidth, as measured according to the Machine Shock Test, of no less than 7 ms, such as no less than 9.5 ms, no less than 15 ms, no less than 20 ms, or even no less than 25 ms.

Item 8. The shell according to any one of items 4-7, wherein the shell comprises:
a body defining an aperture adapted to receive a radiation sensing component; and
a plurality of fins outwardly extending from the body.

Item 9. The shell according to any one of items 2 and 8, wherein an axial distance between a first pair of adjacent fins is different from an axial distance between a second pair of adjacent fins.

Item 10. The shell according to any one of items 1, 2, 3, 8, and 9, wherein the axial distance between the first pair of adjacent fins defines a maximum axial distance, D_{MAX}, as measured between any adjacent fins of the plurality of fins, wherein the axial distance between the second pair of adjacent fins defines a minimum axial distance, D_{MIN}, as measured between any adjacent fins of the plurality of fins, and wherein D_{MAX} is at least 1.1 D_{MIN}, such as at least 1.5 D_{MIN}, or even at least 2.0 D_{MIN}.

Item 11. The shell according to any one of items 1, 2, 3, and 8-10, wherein the axial distance between the first pair of adjacent fins defines a maximum axial distance, D_{MAX}, as measured between any adjacent fins of the plurality of fins, wherein the axial distance between the second pair of adjacent fins defines a minimum axial spacing, D_{MIN}, as measured between any adjacent fins of the plurality of fins, and wherein D_{MAX} is no greater than 20 D_{MIN}, such as no greater than 10 D_{MIN}, or even no greater than 5 D_{MIN}.

Item 12. The shell according to any one of items 1 and 9-11, wherein one of the fins as used to measure the axial distance between the first pair of adjacent fins is disposed closest to a first longitudinal end of the body, and wherein one of the fins as used to measure the axial distance between the second pair of adjacent fins is disposed closest to a second longitudinal end of the body.

Item 13. The shell according to any one of items 1 and 9-12, wherein an axial distance between adjacent fins of the plurality of fins increases along an axial length of the body.

Item 14. The shell according to any one of items 1, 2, 3, and 8-13, wherein the plurality of fins extend at least partially around a circumference of the body.

Item 15. The shell according to any one of items 1, 2, 3, and 8-14, wherein at least one fin of the plurality of fins extends around an entire circumference of the body.

Item 16. The shell according to any one of items 1, 2, and 8-15, wherein all fins of the plurality of fins extend around an entire circumference of the body.

Item 17. The shell according to any one of items 1, 2, 3, and 8-16, wherein the shell comprises at least 3 fins, at least 5 fins, or even at least 10 fins.

Item 18. The shell according to any one of items 1, 2, 3, and 8-17, wherein the shell comprises no greater than 50 fins, such as no greater than 30 fins, or even no greater than 15 fins.

Item 19. The shell according to any one of items 1, 2, 3, and 8-18, wherein, when viewed in a direction parallel with the axial length, each fin has a polygonal profile.

Item 20. The shell according to any one of items 1, 2, 3, and 8-19, wherein, when viewed in a direction parallel with the axial length, each fin has a rectangular profile.

Item 21. The shell according to any one of items 1, 2, 3, and 8-20, wherein, when viewed in a direction parallel with the axial length, each fin has a square profile.

Item 22. The shell according to any one of items 1, 2, 3, and 8-21, wherein, when viewed in a direction parallel with the axial length, each fin is devoid of a right-angle corner.

Item 23. The shell according to any one of items 1, 2, 3, and 8-22, wherein, when viewed in a direction parallel with the axial length, each fin is ellipsoidal.

Item 24. The shell according to any one of items 1, 2, 3, and 8-23, wherein each fin of the plurality of fins has an equal thickness.

Item 25. The shell according to any one of items 1, 2, 3, and 8-24, wherein the body comprises a first section and a second section.

Item 26. The shell according to item 25, wherein the first and second sections are adapted to join at a seam.

Item 27. The shell according to item 26, wherein the seam extends along a length of the body.

Item 28. The shell according to any one of items 25-27, wherein the first and second sections are symmetric.

Item 29. The shell according to any one of the preceding items, wherein the shell comprises a polymer, such as a rubber.

Item 30. The shell according to any one of the preceding items, wherein the shell comprises a material having a hardness, as measured according to ASTM D2240, of no less than 30 durometer, such as no less than 60 durometer, or even no less than 90 durometer.

Item 31. The shell according to any one of the preceding items, wherein the shell comprises a material having a hardness, as measured according to ASTM D2240, of no greater than 120 durometer, such as no greater than 110 durometer, or even no greater than 100 durometer.

Item 32. The shell according to any one of the preceding items, wherein the shell has a mass of no greater than 1000 g, such as no greater than 750 g, no greater than 500 g, or even no greater than 300 g.

Item 33. The shell according to any one of items 1, 2, 3, and 8-32, wherein the shell has a mass of at least 20 g, such as at least 100 g, or even at least 250 g.

Item 34. The shell according to any one of items 1, 2, 3, and 8-33, wherein the aperture of the body defines a first portion and a second portion, and wherein the first portion has a diameter greater than the second portion.

Item 35. The shell according to item 34, wherein a fin density along the second portion, FD_{SP}, is greater than a fin density along the first portion, FD_{FP}.

Item 36. The shell according to item 35, wherein FD_{SP} is at least 1.1 FD_{FP}, such as at least 1.2 FD_{FP}, at least 1.5FD_{FP}, or even at least 2.0 FD_{FP}.

Item 37. The shell according to any one of items 35 and 36, wherein FD_{SP} is no greater than 10.0 FD_{FP}, such as no greater than 5 FD_{FP}, or even no greater than 2.5 FD_{FP}.

Item 38. The shell according to any one of the preceding items, wherein a center of gravity of the shell is spaced apart from a center point of the shell.

Item 39. The shell according to any one of items 34-38, wherein the aperture of the body further defines a third portion disposed axially between the first and second portions, wherein the third portion comprises a radial transition between the first and second portions.

Item 40. The shell according to any one of items 1, 2, 3, and 8-39, wherein a first outer edge of each of the plurality of fins lies along a first plane.

Item 41. The shell according to item 40, wherein a second outer edge of each fin of the plurality of fins lies along a second plane that intersects the first plane.

Item 42. The shell according to any one of items 1, 2, 3, and 8-41, wherein the body defines a hole extending radially from an outer surface of the body in a direction toward the aperture.

Item 43. The shell according to any one of items 1, 2, 3, and 8-42, wherein at least one fin of the plurality of fins defines a hole extending through a thickness of the fin.

Item 44. The shell according to any one of items 1, 2, 3, and 8-43, wherein the shell further comprises at least one axial fin extending from the body in a direction generally parallel with an axial length of the body.

Item 45. A radiation detector assembly comprising:
a housing having a cavity, the housing having a major surface including a joint;
a radiation sensing component disposed within the cavity; and
the shell according to any one of the preceding items, wherein the shell is disposed between the housing and the radiation sensing component, the shell having a major surface including a seam,
wherein the major surface of the housing is oriented parallel to the major surface of the shell.

Item 46. The radiation detector according to item 45, wherein the joint extends axially along the housing.

Item 47. The radiation detector according to any one of items 45 and 46, wherein the seam extends axially along the shell.

Item 48. The radiation detector according to any one of items 45-47, wherein the joint and the seam are disposed on different planes.

Item 49. The radiation detector according to any one of items 45-48, wherein the joint and the seam are not contiguous.

Item 50. A radiation detector assembly comprising:
a housing having a cavity;
a radiation sensing component disposed within the cavity; and
the shell according to any one of the preceding items, wherein the shell is disposed between the housing and the radiation sensing component.

Item 51. The radiation detector according to any one of items 45-50, wherein the housing further comprises a handle.

Item 52. The radiation detector according to any one of items 45-51, wherein the radiation detector further comprises a display.

Item 53. The shell or radiation detector assembly according to any one of the preceding items, wherein the radiation detector is handheld.

Item 54. The shell or radiation detector assembly according to any one of the preceding items, wherein the radiation detector has a mass of less than 5 kg, such as less than 4 kg, or even less than 3 kg.

Item 55. The shell or radiation detector assembly according to any one of the preceding items, wherein the radiation detector has a mass of at least 0.05 kg.

### EXAMPLES

The examples are demonstrative and are not intended to limit the scope of the embodiments described above.

Sample 1 is a radiation sensing assembly including a shell made from a material having a durometer of 60. The shell includes eight fins and six axial fins positioned on a plane extending from an axial end of the housing. The shell includes two components joined at a seam extending parallel with an axial length of the shell.

Sample 2 is a radiation sensing assembly including a shell made from a material having a durometer of 90. The shell includes eight fins and six axial fins positioned on a plane extending from an axial end of the housing. The shell includes two components joined at a seam extending parallel with an axial length of the shell.

According to the Machine Shock Test, a radiation sensing component (or simulated component having similar structural size, shape, and weight) is positioned within the aperture of the shells of Samples 1 and 2. An accelerometer is attached to the top side of the radiation sensing component. The Samples are secured to the plate of a shock machine adapted to deliver 120 G-force to the plate. The shock machine is operated for 100 cycles. A peak force and pulse width, as measured by the accelerometer, is recorded. Table 1 illustrates the recorded values.

TABLE 1
Recorded Data from Machine Shock Test

| | | Sample 1 | Sample 2 |
|---|---|---|---|
| Peak Force | Maximum | 239.63 | 181.65 |
| (G-Peak) | Average | 220.03 | 169.77 |
| Pulse Width | Maximum | 9.26 | 9.73 |
| (ms) | Minimum | 7.27 | 9.25 |
| | Average | 7.83 | 9.02 |

As illustrated in Table 1, Sample 2 had a decreased average and maximum peak force as compared to Sample 1, while having an increased average and minimum pulse width. Specifically, Sample 2 had a 23% decreased average peak force as compared to Sample 1. Moreover, Sample 2 had a 15% increased average pulse width as compared to Sample 1. For further testing, an NaI(Tl) radiation detector is inserted into the aperture of Sample 2. Prior to inserting the radiation detector into the aperture of Sample 2, the initial pulse height and pulse height resolution of the detector is recorded. The pulse height and pulse height resolution of the detector are again measured and recorded after insertion of the detector into the aperture. Sample 2 is then raised above a concrete floor and dropped twice from distances of 30.5 cm, 45.7 cm, 70.0 cm, and 99.0 cm. After each successive drop, the pulse height and pulse height resolution are again measured and recorded. Table 2 illustrates the recorded values.

TABLE 2
Recorded Data from Drop against Concrete Floor

| Drop Height | | Pulse Height |
|---|---|---|
| (cm) | Pulse Height | Resolution |
| Initial | 1817 | 6 |
| Within Housing | 1837 | 6 |
| 30.5 | 1834 | 6 |
| | 1831 | 6 |
| 45.7 | 1812 | 6 |
| | 1831 | 6 |
| 70.0 | 1843 | 6 |
| | 1835 | 6 |
| 99.0 | 1873 | 6 |
| | 1838 | 6 |

From the results illustrated in Table 2, the radiation sensing assembly of Sample 2 is rated to withstand an impact from a height of at least 99.0 cm without imparting damaging forces upon the radiation sensing component.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A shell for a radiation sensor comprising:
a body defining an aperture adapted to receive a radiation sensing component; and
a plurality of fins outwardly extending from the body, wherein an axial distance between a first pair of adjacent fins is different from an axial distance between a second pair of adjacent fins.

2. The shell according to claim 1, wherein the shell is adapted to transmit a pulse having a pulse width, as measured according to the Machine Shock Test, of no less than 7 ms.

3. The shell according to claim 1, wherein one of the fins as used to measure the axial distance between the first pair of adjacent fins is disposed closest to a first longitudinal end of the body, and wherein one of the fins as used to measure the axial distance between the second pair of adjacent fins is disposed closest to a second longitudinal end of the body.

4. The shell according to claim 1, wherein the aperture of the body defines a first portion and a second portion, wherein the first portion has a diameter greater than the second portion, and wherein a fin density along the second portion, FD_{SP}, is greater than a fin density along the first portion, FD_{FP}.

5. The shell according to claim 1, wherein at least one fin of the plurality of fins defines a hole extending through a thickness of the fin.

6. The shell according to claim 1, wherein the shell further comprises at least one axial fin extending from the body in a direction generally parallel with an axial length of the body.

7. The shell according to claim 1, wherein the plurality of fins extend at least partially around a circumference of the body.

8. The shell according to claim 1, wherein the shell is adapted to be disposed within a housing of a radiation detector assembly between the housing and the radiation sensing component.

9. The shell according to claim 8, wherein the shell comprises a major surface having a seam, wherein the housing of the radiation detector assembly comprises a joint along a major surface thereof, and wherein the major surface of the housing is oriented parallel to the major surface of the shell.

10. A shell for a radiation sensor comprising:
a body defining an aperture adapted to receive a radiation sensing component; and
a plurality of fins outwardly extending from the body,
wherein the plurality of fins extend a radial distance from the body, and wherein a radial distance of a first fin from an outer surface of the body is different than a radial distance of a second fin as measured from the outer surface of the body.

11. The shell according to claim 10, wherein the plurality of fins extend at least partially around a circumference of the body.

12. The shell according to claim 10, wherein, when viewed in a direction parallel with the axial length, each fin has a polygonal profile.

13. The shell according to claim 10, wherein a center of gravity of the shell is spaced apart from a center point of the shell.

14. The shell according to claim 10, wherein the shell further comprises at least one axial fin extending from the body in a direction generally parallel with an axial length of the body.

15. The shell according to claim 10, wherein the shell is adapted to transmit a G-peak, as measured according to the Machine Shock Test, of less than 400 G-peak.

16. A shell for a radiation sensor, wherein the shell is adapted to transmit a G-peak, as measured according to the Machine Shock Test, of less than 400 G-peak.

17. The shell according to claim 16, wherein the shell is adapted to transmit a pulse to the radiation sensor, the pulse having a pulse width, as measured according to the Machine Shock Test, of no less than 15 ms.

18. The shell according to claim 16, wherein the shell comprises:
a body defining an aperture adapted to receive a radiation sensing component; and
a plurality of fins outwardly extending from the body.

19. The shell according to claim 16, wherein the shell comprises a material having a hardness, as measured according to ASTM D2240, of no less than 60 durometer.

20. The shell according to claim 18, wherein a first outer edge of each of the plurality of fins lies along a first plane.
